(19) United States
(12) Patent Application Publication
(10) Pub. No.: US 2008/0171450 A1
(43) Pub. Date: Jul. 17, 2008

(54) Wafer Bump Manufacturing Using Conductive Ink

(75) Inventors: Petri Molkkari, Tampere (FI); Pauliina Mansikkamaki, Hameenkyro (FI); Matti Mantysalo, Tampere (FI); Jani Miettinen, Hyvincaa (FI); Jani Valtanen, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/622,770

(22) Filed: Jan. 12, 2007

(51) Int. Cl. H01R 12/00

(52) U.S. Cl. 439/65; 156/60

(57) ABSTRACT

The invention is related to a method of manufacturing connection bumps on substrates, and in particular to a connection bump formed by depositing conductive ink and placing a conductive element on top of the ink. The final connection bump is formed by curing the conductive ink, thus providing a conductive attachment of the conductive element to a substrate surface. Ink-jet printing may be used for depositing ink on the surface.

### TECHNICAL FIELD

The invention is related to wafer bump manufacturing, and in particular to the use of ink-jet printing techniques for providing bumps on a substrate.

### RELATED ART

Integrated circuits (ICs) and semiconductor devices are used in many areas and products. Basically, miniaturized electronic circuits and connection elements are provided on a semiconductor wafer, which is then divided into a plurality of single dies or chips. One or more dies are packaged to provide a semiconductor device for assembly in electronic devices. Therefore, connections between several dies, connection pins for external interfaces, and other electrical connections have to be formed.

In approaches like System-in-Package (SiP) or Multi Chip Module (MCM), several dies are combined in a single package to provide all functions of a complete system or module within a single package. Also, dies of different material and/or production technologies may be combined in one package. Thus, overall size and cost of a device may be considerably reduced, while providing all functions with only one module. For example, a memory die may be combined with a controller and a signal filter in one package. Various dies are mounted on a substrate or leadframe, either in horizontal (next to each other) or vertical (on top of each other) arrangement. The substrate may be made from any suitable material, such as a semiconductor (e.g. silicon), polymer, or ceramic. To protect the dies from any external influences, the substrate with mounted dies is then typically packaged by adding a non-conductive material around the components. Materials commonly used for this encapsulation are, for example, epoxy, polymer, or ceramic.

The required electrical connection between a die and the substrate (or between several dies) may be obtained using fine wires. Another approach is known as flip-chip structure or direct attach. In this type of die attachment, solder bumps or beads are deposited on the substrate. The die to be attached on the substrate surface is then turned with its functional surface upside down (hence the term “flip chip”) and connected to the substrate by reflowing the solder. Several methods for depositing solder bumps are known. For example, chemical vapor deposition, stencil printing, microballing (ball grid arrays) and stud bumping are commonly used to form small bumps at desired locations on a wafer substrate.

For stencil printing, a screen or stencil is used to define the areas to be printed on a wafer, and solder paste is applied by stroking it across the stencil disposed over the substrate/wafer. Wastage of solder material and the cost and contamination involved is a prevailing problem of such bumping methods. Stud bumping is implemented by using techniques similar to the long-known ball-bonding procedure, typically pressing a melting wire tip of gold wire (or other suitable material) onto the surface to form a ball bond and then breaking the wire right after the bond. Bumps may be flattened or otherwise reshaped afterwards by e.g. pressure applied to the surface.

These known bump manufacturing techniques are thus relatively inflexible, tedious, and expensive procedures, and usually not profitable for e.g. prototyping and flexible production of electronic components. Contamination of wafer surfaces in contact methods is also unfavorable.

### SUMMARY

A method is provided comprising: depositing at least one layer of a conductive ink on selected locations of a substrate surface; placing an element made of a conductive material on said at least one layer of conductive ink; and curing said at least one deposited layer of conductive ink. Thus, the conductive ink is used as an electrical connection between the conductive element and the surface, and at the same time fixing the conductive element to the surface. Bump shape and size as well as further properties may be controlled by varying both the applied ink volume and depositing area, and the attached conductive element.

In some embodiments, the method may further comprise curing one or more layers of deposited ink before depositing further layers, wherein at least one layer of ink is not cured until after said placing of a conductive element. In this way, a conductive basis may be shaped for placing a conductive element, and the at least one uncured ink layer serves to connect the element to the surface.

In exemplary embodiments, said conductive element is essentially spherical. This may be a solder ball or another metallic ball, which is easy to produce and place on the desired location, and also provides a good connection bump.

Such a placed conductive element may have essentially the same dimensions as said selected locations of deposited ink.

Said layer of ink may be formed by a droplet of ink in exemplary embodiments of the above methods. A single drop may be used to deposit a limited volume of ink in a well-defined and controllable area. In other embodiments, several droplets next to each other or overlapping may be used to cover a specific area with ink.

The curing is in exemplary embodiments achieved by heating at least a part of said substrate surface.

In some embodiments, the depositing of ink onto said substrate surface comprises jet-printing of said ink. This jet-printing of ink may in some embodiments be achieved by inducing mechanical pressure waves in an ink reservoir having an aperture. Pressure waves for this purpose may e.g. be generated by a piezo-electric element. A piezo element may be easily controlled to vary drop size, and e.g. different waveforms may be used to control the jet-printing process.

In exemplary embodiments of the invention, said substrate may comprise a semiconductor material, such as a semiconductor die including integrated circuits; it may also comprise in further embodiments a ceramic material, a polymer material, or a metal or metal alloy.

According to another aspect of the invention, a device is provided comprising a jet printing head connected to at least one reservoir for depositing conductive and/or dielectric ink on a substrate; an actuator capable of placing conductive elements on areas of deposited ink on said substrate; and a heating element for curing said deposited conductive and/or dielectric ink.

### BRIEF DESCRIPTION OF FIGURES

In the following, exemplary embodiments of the invention will be explained in more detail with reference to the appended figures, wherein

FIG. 1 a to d show several stages of an exemplary bump manufacturing procedure; and

FIG. 2 illustrates exemplary method steps for manufacturing a bump as in FIG. 1.

### DETAILED DESCRIPTION OF EXEMPLARY EMBODIMENTS

A non-contact deposition of dots and layers of ink on carriers may be performed in several ways. In exemplary embodiments, a printing device similar to an ink-jet printer may be used to obtain small dots placed at selected positions. In particular embodiments, this may be a demand-mode jet printer, that is, a printer that ejects a defined quantity of ink (only) when desired. Such a jet printer may utilize a reservoir filled with an essentially liquid printing ink, having an aperture to eject droplets of ink. A droplet may be produced by mechanically inducing pressure waves into the ink reservoir. For example, a piezo-electric element may be included which induces pressure waves in the reservoir, the piezo-electric element being driven by a defined and controllable operating voltage.

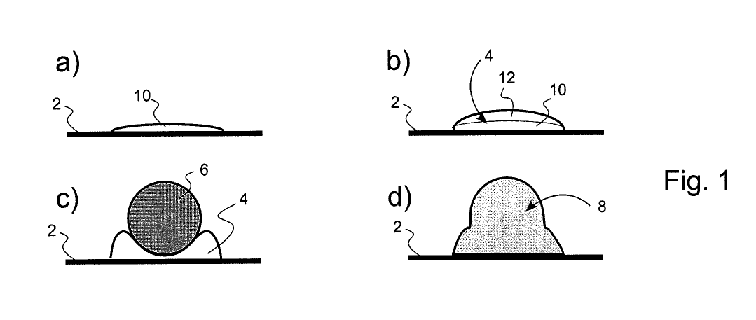

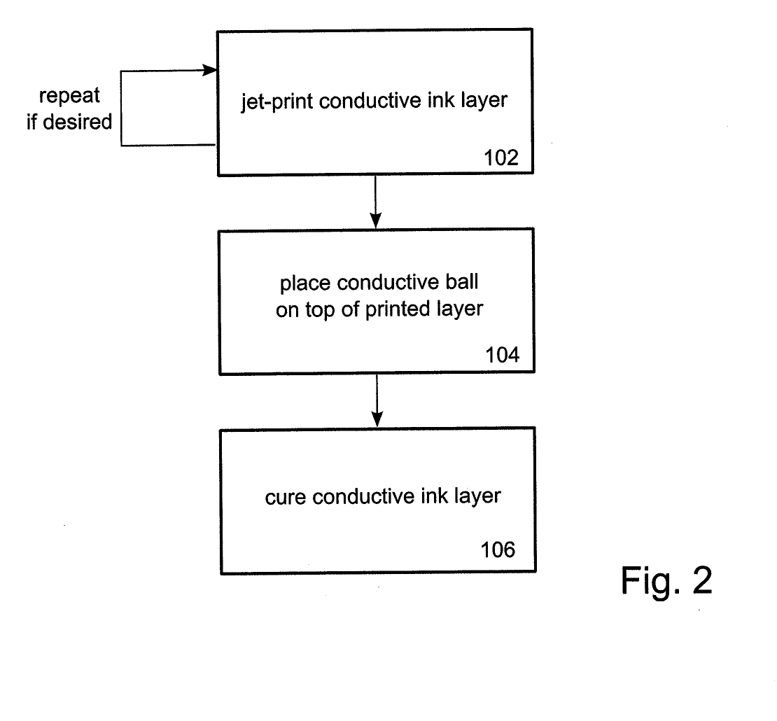

A bump made of a conductive material may be produced by depositing one or several layers of printed ink 10, 12 onto a substrate surface 2, and attaching a conductive element 6 placed on the printed ink by curing the ink. In this way, a connection bump 8 is formed after curing, composed of the conductive element 6 and the cured ink volume 4. Exemplary method steps and manufacturing stages for such a bump will be discussed in the following, first referring to FIG. 1 for the structural details of a bump in various manufacturing stages and to FIG. 2 for respective method steps.

In a first step (step 102 of FIG. 2), a first layer 10 of ink is applied on the substrate surface 2. This layer 10 may be provided in a spatially limited area having a size suitable for a connection bump. The size of the bump part 4 to be printed is variable and may be controlled by controlling droplet volume and jetting parameters, such as impact velocity and angle, in an ink jetting process. Thus, a layer of ink 10 may e.g. be applied by depositing a single droplet of ink on the desired surface area. Subsequently, the first deposited ink layer 10 may be cured and thus connects to the surface 2. If no further ink drops or layers are to be applied before placing the conductive element, this layer is not cured at this point. Curing procedures will be discussed in more detail below. After curing, a further layer 12 of ink may be applied, e.g. by ink jetting another droplet (or several drops) of ink onto the same limited area where the first layer has been placed, in order to obtain a specific volume (or shape) of ink for attaching an element to the substrate. This layer 12 may again be cured similar to the first one, and connects to the previous layer. Depositing of further layers and curing the layers may be repeated as often as necessary or desired. This is indicated by the “repeat loop” in the method diagram of FIG. 2. Also, several drops or layers of ink may be cured in a single curing step, and then further layers may be applied and left uncured. Of course, usually it is not decided during the manufacturing procedure whether to apply another layer, but rather in advance by defining a bump profile to be generated and then adapting the printing process to this profile. However, for instance in prototyping or experimental applications, it is also conceivable to check the current bump appearance and then to apply further layers if necessary or desired. At least one last layer is left uncured to subsequently attach the conductive element, and cured after placing the element to form a fixed connection to the substrate. Alternatively, a single ink drop 10 of controlled size/volume may be deposited in step 102 to form the connecting ink volume 4. Conductive ink may be used for this ink basis, as it is intended to form the conductive joint between the additional element and the substrate surface 2.

When a sufficient amount 4 of conductive ink has been deposited, a conductive element 6 may be placed on top of the deposited ink volume 4, as shown in FIG. 1c and indicated by step 104 of FIG. 2. This element 6 may e.g. be a spherical element such as a metallic ball, but other shapes are equally conceivable. An element 6 may for example be made from a solder alloy, a polymer, a metal such as gold, silver or copper, or any other suitable conductive material. After the element 6 has been placed on the uncured ink layer 4, the conductive ink may be cured in step 106, thus attaching the element 6 and forming a conductive joint between the element 6 and the underlying carrier surface 2. A resulting bump 8 is shown in FIG. 1d. However, the shape of this bump 8 is only exemplary and may vary due to ink viscosity, element 6 size and shape, and other parameters. When the element 6 such as a ball is heavy in relation to the viscosity of the uncured ink, the element may sink through an ink drop all the way to the carrier surface, at least partially enclosed by liquid uncured ink and subsequently fixed by curing the ink 4. In some embodiments, dimensions of the placed element 6 may be in the range of the deposited ink structure 4. More complicated element structures and shapes besides the shown spherical element are conceivable, depending on the desired properties of the resulting connection bump. Placement of a conductive element on an ink bump, as in the exemplary embodiment of FIG. 1, may be done in various ways, as will be understood by the person skilled in the art.

The conductive ink used to form the bump base 4 and thus the connection between ball 6 and substrate 2 in the example above may comprise conductive particles to provide an electronic connection. For example, nano-particles of silver, copper, gold or another suitable material or compound may be dispersed in a medium, comprising solvents, detergents/surfactants, filler materials, and further components. The substrate or carrier 2 for placing the bumps may for example be a semiconductor wafer or single die, a polymer, ceramic or metallic material, or any other suitable substrate material.

Curing (step 106 of FIG. 2) of the ink layers or drops may be performed in several ways. Naturally, the curing procedure will be dependent on the specific type of ink used for printing and its constituents. Temperature and pressure as well as the type of atmosphere present (e.g. air or nitrogen) may also have an influence on the ink properties and may thus be used to control a curing procedure. In some embodiments, the printed carrier or only a part of a carrier may be exposed to heat to volatilize solvents, or to set a thermosetting polymer. Surface characteristics of the carrier surface 2 also may have an effect on the curing procedure and e.g. on shapes and sizes of the finalized printed layers and bumps after curing. Curing time and process may be similarly dependent on such parameters, but also on printed element size, since e.g. solvent in an ink droplet with smaller surface will take less time to vaporize.

Bumps 8 like those described above may be used for many packaging systems, such as MCM (multi chip module), SiP (system on package), SoP (system on package) and comparable systems. In general, they may be applied to any system requiring conductive bumps to be produced on a surface.

Also, in some embodiments several bumps 4 could be formed in each step, i.e. in a first stage a basic layer 10 of ink may be applied to several small locations/areas of a wafer 2, defining a plurality of bump locations; then all first ink layers 10 on the wafer 2 may optionally be cured, and a number of further layers 12 may be applied and cured as desired. Then, conductive elements may be placed on the ink volumes, and finally the ink may be cured again to attach all conductive elements across the substrate. It is possible to use different conductive elements on various locations of a surface. Bumps of varying heights and/or shape on a single wafer may be easily formed by such a method. The size of a bump, both two-dimensional bump area and three-dimensional profile, may for instance be controlled by using different volumes of ink, different waveforms for producing droplets, or varying falling parameters of ink droplets. Therefore, the smallest bump size that can be produced by a printing process is within the range of a minimum droplet size of the used ink depositing system such as an ink-jet printer, and of course also depending on the size of the custom-made conductive element placed on the ink volume.

In all cases, further steps and manufacturing stages besides those shown and discussed may be included in a bump manufacturing process, method steps may be exchanged in order, and some stages may optionally be left out. For example, a single drop of ink may be sufficient to attach a ball-like element to a surface, and it would then not be necessary to repeat the ink layer depositing as shown in FIG. 1b. Ink layers of different size or volume may be applied by varying droplet size or placing several droplets of ink next to each other, such that e.g. a larger area may be printed in a first layer, but a smaller one in further layers.

Although exemplary embodiments of the present invention have been described, these should not be construed to limit the scope of the appended claims. Those skilled in the art will understand that various modifications may be made to the described embodiments and that numerous other configurations or combinations of any of the embodiments are capable of achieving this same result. Moreover, to those skilled in the various arts, the invention itself will suggest solutions to other tasks and adaptations for other applications. It is the applicant's intention to cover by claims all such uses of the invention and those changes and modifications which could be made to the embodiments of the invention herein chosen for the purpose of disclosure without departing from the spirit and scope of the invention.

What is claimed is:

1. A method comprising
depositing at least one layer of a conductive ink on selected locations of a substrate surface;
placing a element made of a conductive material on said at least one layer of conductive ink; and
curing said at least one deposited layer of conductive ink.

2. The method of claim 1, further comprising
curing one or more layers of deposited ink before depositing further layers, wherein at least one layer of ink is not cured until after said placing of a conductive element.

3. The method of claim 1, wherein said conductive element is essentially spherical.

4. The method of claim 1, wherein said placed conductive element has essentially the same dimensions as said selected locations of deposited ink.

5. The method of claim 1, wherein said at least one layer of ink is formed by a droplet of ink.

6. The method of claim 1, wherein said curing is achieved by heating at least a part of said substrate surface.

7. The method of claim 1, wherein said depositing of ink onto said substrate surface comprises jet-printing of said ink.

8. The method of claim 7, wherein said jet-printing of ink is achieved by inducing mechanical pressure waves in an ink reservoir having an aperture.

9. The method of claim 8, wherein said pressure waves are generated by a piezo-electric element.

10. The method of claim 1, wherein said substrate comprises a semiconductor material.

11. The method of claim 1, wherein said substrate is a semiconductor die including integrated circuits.

12. The method of claim 1, wherein said substrate comprises a ceramic material.

13. The method of claim 1, wherein said substrate comprises a polymer material.

14. The method of claim 1, wherein said substrate comprises a metal or a metal alloy.

15. A connection element comprising
at least one layer of a cured conductive ink; and
a conductive element on top of and attached to said at least one layer of cured conductive ink.

16. The connection element of claim 15, wherein said at least one layer of cured conductive ink is located on a limited area of a substrate surface.

17. The connection element of claim 15, wherein said conductive element is at least in part enclosed by said at least one layer of conductive ink.

18. A die substrate comprising at least one connection element according to claim 15.
